(19) United States
(12) Patent Application Publication
(10) Pub. No.: US 2025/0239868 A1
(43) Pub. Date: Jul. 24, 2025

(54) BATTERY CHARGE BALANCING

(71) Applicant: GM GLOBAL TECHNOLOGY OPERATIONS LLC, Detroit, MI (US)

(72) Inventors: Jun-mo Kang, Ann Arbor, MI (US); Manjit Swami, Westland, MI (US); Dave G. Rich, Sterling Heights, MI (US); Davin A. Jankovics, Oshawa (CA); Aaditya Geed, Toronto (CA)

(73) Assignee: GM GLOBAL TECHNOLOGY OPERATIONS LLC, Detroit, MI (US)

(21) Appl. No.: 18/416,012

(22) Filed: Jan. 18, 2024

(51) Int. Cl. H02J 7/00; B60L 58/12; B60L 58/22

(52) U.S. Cl. CPC H02J 7/0019; B60L 58/12; B60L 58/22; H02J 7/0048; H02J 7/007194

(57) ABSTRACT

A method for controlling a plurality of energy storage elements in a vehicle having a first power bus and a second power bus includes, for a first time interval, connecting a first subset of the plurality of energy storage elements to the first power bus and a second subset of the plurality of energy storage elements to the second power bus; and for a second time interval, connecting the first subset of energy storage elements to the second power bus and the second subset of energy storage elements to the first power bus to increase equalization of states of charge between the first subset of energy storage elements and the second subset of energy storage elements.

### INTRODUCTION

This disclosure is in the field of battery charge balancing.

In electrical systems of vehicles such as electric vehicles, storage elements such as batteries may provide electrical energy storage. As the electrical system operates, imbalances among the states of charge of the batteries may develop. Balancing the states of charge of the batteries may help improve the consistency of energy delivery by the batteries and improve the batteries' storage capability.

### SUMMARY

A method for controlling a plurality of energy storage elements in a vehicle having a first power bus and a second power bus includes for a first time interval, connecting a first subset of the plurality of energy storage elements to the first power bus and a second subset of the plurality of energy storage elements to the second power bus. The method also includes, for a second time interval, connecting the first subset of energy storage elements to the second power bus and the second subset of energy storage elements to the first power bus to increase equalization of states of charge between the first subset of energy storage elements and the second subset of energy storage elements.

The method may include selecting at least two of the energy storage elements based at least in part on their states of charge and including the at least two energy storage elements in the first subset of the plurality of energy storage elements. The method may include selecting at least two of the energy storage elements based at least in part on their temperatures and including the at least two energy storage elements in the first subset of the plurality of energy storage elements. The first time interval and the second time interval may be determined by one or more controllers using model predictive control and may each be greater than or equal to zero seconds.

The method may also include changing connections among the plurality of energy storage elements so that one of the energy storage elements of the first subset of the plurality of energy storage elements is contained in the second subset of energy storage elements and one of the energy storage elements of the second subset of energy storage elements is contained in the first subset of energy storage elements; for a third time interval, connecting the first subset of the plurality of energy storage elements to the first power bus and the second subset of the plurality of energy storage elements to the second power bus; and for a fourth time interval, connecting the first subset of energy storage elements to the second power bus and the second subset of energy storage elements to the first power bus to increase equalization of states of charge between the first subset of energy storage elements and the second subset of energy storage elements. The third time interval and the fourth time interval may be determined by one or more controllers using model predictive control.

The method may also include changing connections among the plurality of energy storage elements so that one of the energy storage elements of the first subset of the plurality of energy storage elements is swapped in the first subset of energy storage elements with one other of the energy storage elements in the first subset of energy storage elements; for a third time interval, connecting the first subset of the plurality of energy storage elements to the first power bus and the second subset of the plurality of energy storage elements to the second power bus; and for a fourth time interval, connecting the first subset of energy storage elements to the second power bus and the second subset of energy storage elements to the first power bus to increase equalization of states of charge between the first subset of energy storage elements and the second subset of energy storage elements. The third time interval and the fourth time interval may be determined by one or more controllers using model predictive control.

A second method for controlling a plurality of energy storage elements in a vehicle includes identifying a plurality of subsets of the energy storage elements. The method also includes for a first time interval, connecting a first group of the plurality of subsets to a first power bus in the vehicle and connecting a second group of the plurality of subsets, representing a remainder of the subsets not in the first group, to a second power bus in the vehicle. The method further includes selecting a first number of the subsets in the first group, selecting a second number of the subsets in the second group, the first number being equal to the second number. For a second time interval, the selected subsets in the first group are connected to the second power bus and the selected subsets in the second group are connected to the first power bus.

The second method may include selecting the first time interval and the second time interval using model predictive control. The second method may also increase a state of charge balance among the subsets of energy storage elements.

A vehicle includes a first power bus, a second power bus, and a plurality of energy storage elements. The vehicle also includes one or more controllers. The one or more controllers collectively execute the following instructions: for a first time interval, connect a first subset of the plurality of energy storage elements to the first power bus and a second subset of the plurality of energy storage elements to the second power bus; and for a second time interval, connect the first subset of energy storage elements to the second power bus and the second subset of energy storage elements to the first power bus.

The vehicle may further include one or more controllers that execute an instruction to select at least two energy storage elements based at least in part on their states of charge to include in the first subset of the plurality of energy storage elements. Additionally, the vehicle may include one or more controllers that execute an instruction to select at least two energy storage elements based at least in part on their temperatures to include in the second subset of energy storage elements. The first time interval and the second time interval may be determined by one or more controllers using model predictive control to increase equalization of states of charge between the first subset of energy storage elements and the second subset of energy storage elements.

The vehicle may also include one or more controllers that collectively execute the following instructions: change connections among the plurality of energy storage elements so that at least one of the energy storage elements of the first subset of the plurality of energy storage elements is contained in the second subset of energy storage elements and at least one of the energy storage elements of the second subset of energy storage elements is contained in the first subset of energy storage elements; for a third time interval, connect the first subset of the plurality of energy storage elements to the first power bus and the second subset of the plurality of energy storage elements to the second power bus; and for a fourth time interval, connect the first subset of energy storage elements to the second power bus and the second subset of energy storage elements to the first power bus to increase equalization of states of charge between the first subset of energy storage elements and the second subset of energy storage elements. The third time interval and the fourth time interval may be determined by one or more controllers using model predictive control.

The above summary does not represent every embodiment or every aspect of this disclosure. The above-noted features and advantages of the present disclosure, as well as other possible features and advantages, will be readily apparent from the following detailed description of the embodiments and best modes for carrying out the disclosure when taken in connection with the accompanying drawings and appended claims. Moreover, this disclosure expressly includes combinations and sub-combinations of the elements and features presented above and below.

### BRIEF DESCRIPTION OF THE DRAWINGS

FIG. 1 shows a vehicle that includes an electrical system.

FIG. 2 shows a part of the electrical system of the vehicle of FIG. 1.

FIG. 3 shows a portion of the electrical storage system of the vehicle.

FIG. 4A shows a configuration of an isolation mode where a subset of batteries is connected to a first power bus and the remainder are connected to a second power bus.

FIG. 4B shows a second configuration of the isolation mode of FIG. 4A.

FIG. 4C shows a third configuration of the isolation mode of FIG. 4A.

FIG. 5A shows a configuration of a second isolation mode where a subset of batteries is connected to the first power bus and the remainder are connected to the second power bus.

FIG. 5B shows a second configuration of the isolation mode of FIG. 5A.

FIG. 5C shows a third configuration of the isolation mode of FIG. 5A.

FIG. 6A shows a configuration of a third isolation mode where a subset of batteries is connected to the first power bus and the remainder are connected to the second power bus.

FIG. 6B shows a second configuration of the isolation mode of FIG. 6A.

FIG. 7 is a flowchart illustrating a battery charge balancing method.

FIG. 8A shows a configuration of battery strings into battery modules.

FIG. 8B shows a second configuration of battery strings into battery modules.

FIG. 8C shows a third configuration of battery strings into battery modules.

FIG. 9A shows configuration of battery strings into battery modules.

FIG. 9B shows a second configuration of battery strings, where the battery strings are swapped within the battery modules of FIG. 9A.

FIG. 10 shows a model of the electrical storage system of FIG. 3

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

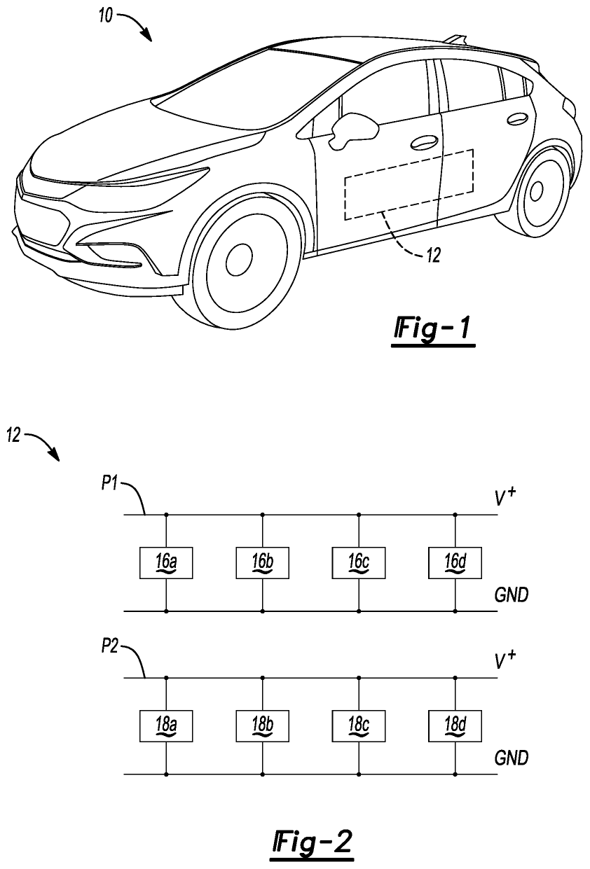

Referring to FIG. 1, a vehicle 10 is illustrated. Vehicle 10 may be an electric vehicle. For the purposes of this disclosure, an “electric vehicle” is a vehicle that uses electrical energy at least in part for propulsion and may be a fully-electric or a hybrid-electric vehicle. Further, vehicle 10 may be any style of vehicle, such as a car, truck, van, sport-utility vehicle, bicycle, scooter, motorcycle, boat, or airplane. If an electric vehicle, vehicle 10 may in general use high voltages for propulsion, such as voltages in the hundreds of volts for powering motors for propelling vehicle 10. However, vehicle 10 may also use one or more lower-voltage buses for supplying low voltage electrical devices on vehicle 10. Vehicle 10 has an electrical system 12.

Referring additionally to FIG. 2, electrical system 12 may include multiple lower-voltage buses, such as bus P1 and bus P2. Bus P1 and bus P2 may each be at a nominal voltage V⁺ referenced to one or more ground (GND) references in vehicle 10. Bus P1 may have a plurality of devices designated 16a, 16b, 16c, and 16d connected thereto for power. Bus P2 may also have a plurality of devices designated 18a, 18b, 18c, and 18d connected thereto for power. While four devices are illustrated on each of bus P1 and bus P2, that is merely for illustration; more or fewer of devices may be provided on bus P1 and bus P2. Bus P1 and bus P2 may be at a nominal voltage of 12 volts DC (direct current). Bus P1 and bus P2 may also be at other nominal voltages, such as 48 volts DC, to which may be connected devices compatible with such other voltages. Bus P1 and bus P2 may be referred to herein as “power buses” or “power supply buses”. While two buses are shown, more than two buses may be provided.

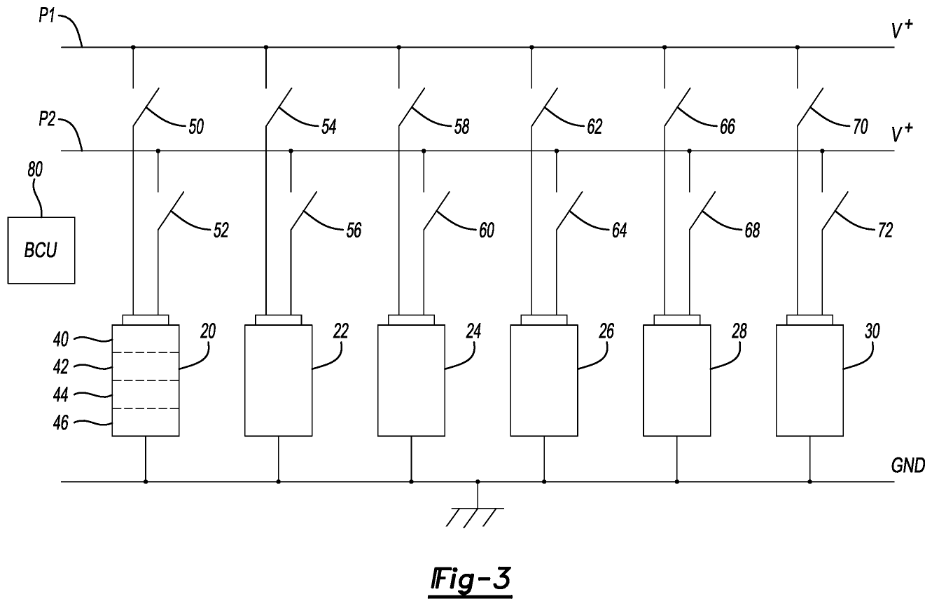

Refer additionally to FIG. 3. There, an electrical energy storage system for vehicle 10 is illustrated. The electrical energy storage system comprises multiple “strings”, or electrical energy storage elements, which may be batteries. String 20, string 22, string 24, string 26, string 28, and string 30 may be provided. Each of the strings may themselves be a series connection of battery cells. That is, string 20 may be comprised of a series connection of battery cell 40, battery cell 42, battery cell 44, and battery cell 46. The battery cells may be of any appropriate technology, such as lithium ferrophosphate (LFP) and may each be three-volt battery cells. The battery cells may also be lithium-ion or other technologies. When referred to collectively herein, the strings may be referred to as “strings 20-30”.

The electrical storage system disclosed herein and comprising strings 20-30 may be a so-called MODACS (Multiple Output Dynamically Adjustable Capacity) system, promoted by General Motors Company.

Strings 20-30 may individually be switchably connectable to bus P1 and to bus P2. String 20 may be connected to bus P1 via a switch 50 and to bus P2 via a switch 52. Additionally, string 22 may be connected to bus P1 via a switch 54 and to bus P2 via a switch 56. Further, string 24 may be connected to bus P1 via a switch 58 and to bus P2 via a switch 60. Also, string 26 may be connected to bus P1 via a switch 62 and to bus P2 by a switch 64. Further yet, string 28 may be connected to bus P1 via a switch 66 and to bus P2 by a switch 68. Additionally, string 30 may be connected to bus P1 via a switch 70 and to bus P2 via a switch 72. When referred to collectively herein, the switches may be referred to as “switches 50-72”.

Switches 50-72 may be semiconductor switches such as insulated-gate bipolar transistors (IGBTs), bipolar junction transistors (BJTs), field-effect transistors (FETs), metal oxide silicon field-effect transistors (MOSFETs), or other suitable technologies for switchably connecting and disconnecting strings 20-30 to and from bus P1 and bus P2. The switches may also be electromechanical relays.

Switches 50-72 may be controlled by a battery control unit (BCU) 80. BCU 80 is understood to have sufficient electrical and electronic resources (microprocessor, memory, software, inputs, outputs, connectivity, and the like) to perform the functions ascribed to BCU 80 herein. Vehicle 10 may also have other controllers that are networked with BCU 80 and that perform some or all of the functions ascribed to BCU 80 herein.

BCU 80 also monitors the charging and discharging of strings 20-30 and is understood to have sufficient electrical connections to strings 20-30 to perform that function. Having knowledge of the charging and discharging currents of strings 20-30, BCU 80 also tracks the states of charge of strings 20-30. BCU 80 or other controllers in vehicle 10 monitor the current draws on bus P1 and bus P2.

BCU 80, which may contain a microprocessor, microcontroller, or other suitable controller, may operate on the basis of instructions, which may include software commands. Further, each instruction may itself carry out or comprise other instructions.

In general operation of vehicle 10, all of switches 50-72 may be closed (or, in the “ON” condition). Thus, all of strings 20-30 would be coupled to provide electrical energy to both bus P1 and bus P2. However, in some cases, it may be desirable to have some of the strings supply only one of bus P1 and bus P2. This may be the case if differing current draw is detected on bus P1 and bus P2. It may also be desirable to isolate certain of devices 16a, 16b, 16c, 16d and/or devices 18a, 18b, 18c, 18d on bus P1 and/or bus P2. Such isolation may be desirable to provide a high level of fault tolerance that may be of advantage for autonomously-driven vehicles.

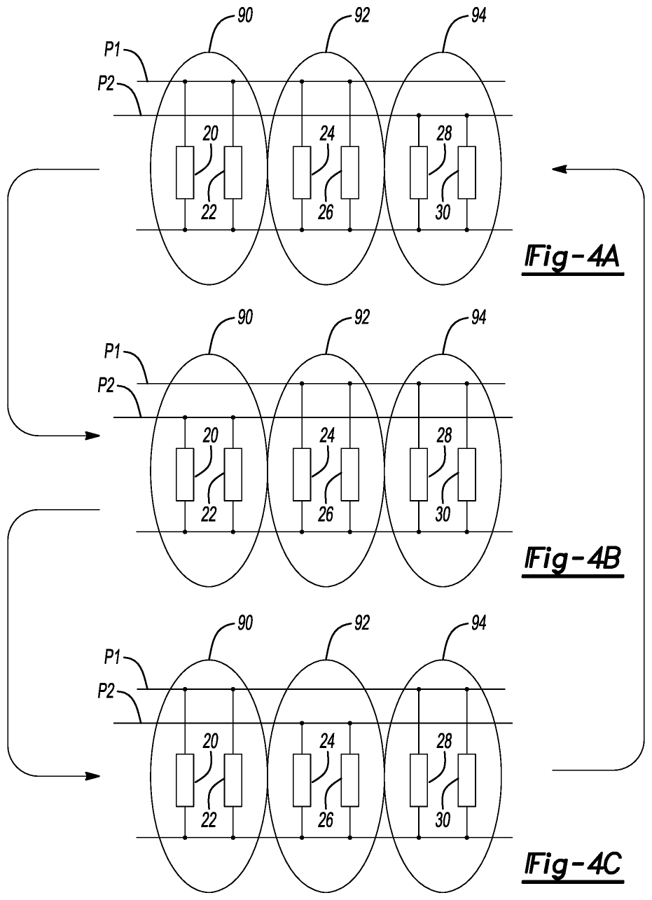

Refer now to FIG. 4A, FIG. 4B, and FIG. 4C. There, a first isolation mode is illustrated where four strings are connected to bus P1 and the remaining two strings are connected to bus P2. As so switched, string 20 and string 22, switched in tandem, may be considered to be a first module 90, string 24 and string 26, switched in tandem, may be considered a second module 92, and string 28 and string 30, switched in tandem, may be considered a third module 94. (Module 90, module 92, and module 94 may each be considered a subset of strings 20-30.) This isolation mode, where two of module 90, module 92, and module 94 are connected to bus P1 and the remaining module is connected to bus P2, will be referred to herein as Isolation Mode 1. FIG. 4A shows one way that module 90, module 92, and module 94 may be connected to bus P1 and bus P2 in Isolation Mode 1. There, module 90 and module 92 are coupled to bus P1 via the closing of switch 50, switch 54, switch 58, and switch 62 and coupled to bus P2 via the closing of switch 68 and switch 72. An alternative way that Isolation Mode 1 may be realized is shown in FIG. 4B. There, module 92 and module 94 are coupled to bus P1 by the closing of switch 58, switch 62, switch 66, and switch 72 and module 90 is coupled to bus P2 via the closing of switch 52 and switch 56. Another alternative way that Isolation Mode 1 may be realized is shown in FIG. 4C. There, module 90 and module 94 are coupled to bus P1 via the closing of switch 50, switch 54, switch 66 and switch 70. Module 92 is coupled to bus P2 via the closing of switch 60 and switch 64.

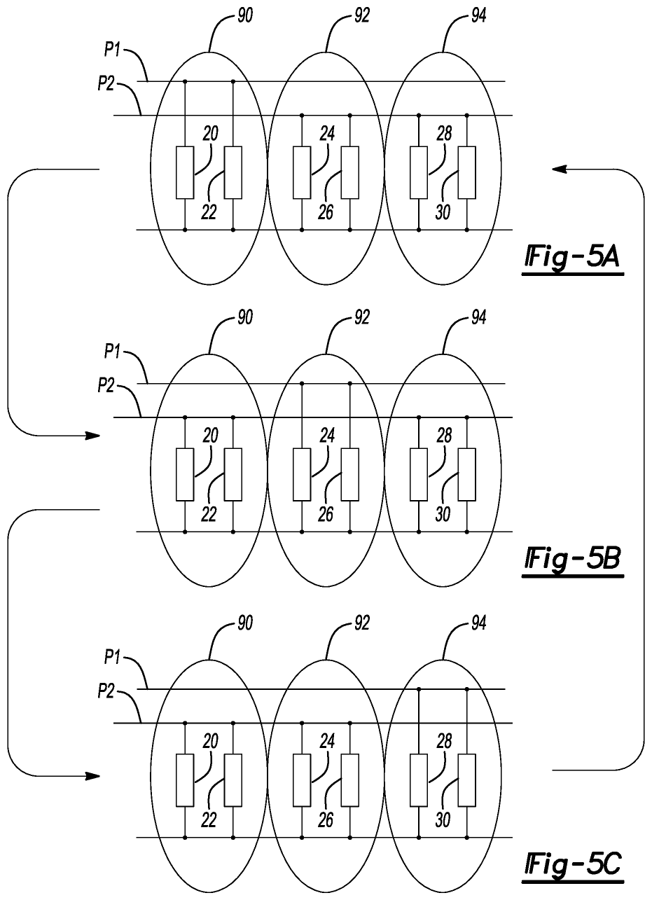

Refer now to FIG. 5A, FIG. 5B and FIG. 5C. There, a second isolation mode (which may be referred to as “Isolation Mode 2”) is illustrated where one module among module 90, module 92, and module 94 is connected to bus P1, and the remaining two modules are connected to bus P2. FIG. 5A shows one way that module 90, module 92, and module 94 may be connected to bus P1 and bus P2 in Isolation Mode 2. There, module 90 is coupled to bus P1 by the closing of switch 50 and switch 54. Module 92 and module 94 are coupled to bus P2 via the closing of switch 60, switch 64, switch 68, and switch 72. An alternative way that Isolation Mode 2 may be realized is shown in FIG. 5B. There, module 92 is coupled to bus P1 via the closing of switch 58 and switch 62. Module 90 and module 94 are coupled to bus P2 via the closing of switch 52, switch 56, switch 68, and switch 72. Another alternative way that Isolation Mode 2 may be realized is shown in FIG. 5C. There, module 94 is coupled to bus P1 via the closing of switch 66 and switch 70. Module 90 and module 92 are coupled to bus P2 via the closing of switch 52, switch 56, switch 60, and switch 64.

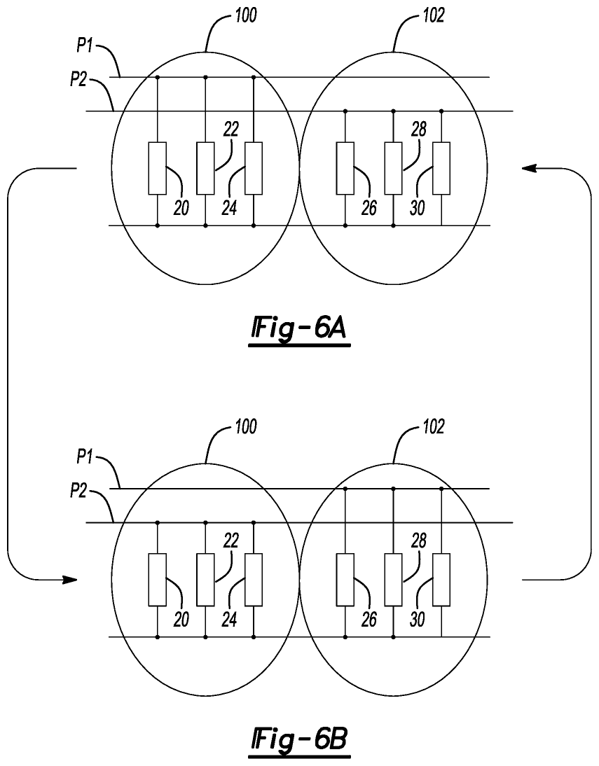

Refer now to FIG. 6A and FIG. 6B. There, a third isolation mode (which may be referred to as “Isolation Mode 3”) is illustrated. There, strings 20-30 may be partitioned into two modules, each comprising three of the strings. Module 100 may be comprised of string 20, string 22, and string 24. Module 102 may be comprised of string 26, string 28, and string 30. In Isolation Mode 3, one module, comprising three strings, may be connected to bus P1 and the other module, comprising the remaining three strings, may be connected to bus P2.

FIG. 6A shows one way that module 100 and module 102 may be connected to bus P1 and bus P2 in Isolation Mode 3. There, module 100 is coupled to bus P1 by the closing of switch 50, switch 54 and switch 58. Module 102 is coupled to bus P2 via the closing of switch 64, switch 68, and switch 72. An alternative way that Isolation Mode 3 may be realized is shown in FIG. 6B. There, module 102 is connected to bus P1 via the closing of switch 62, switch 66, and switch 70. Module 100 is coupled to bus P2 via the closing of switch 52, switch 56, and switch 60.

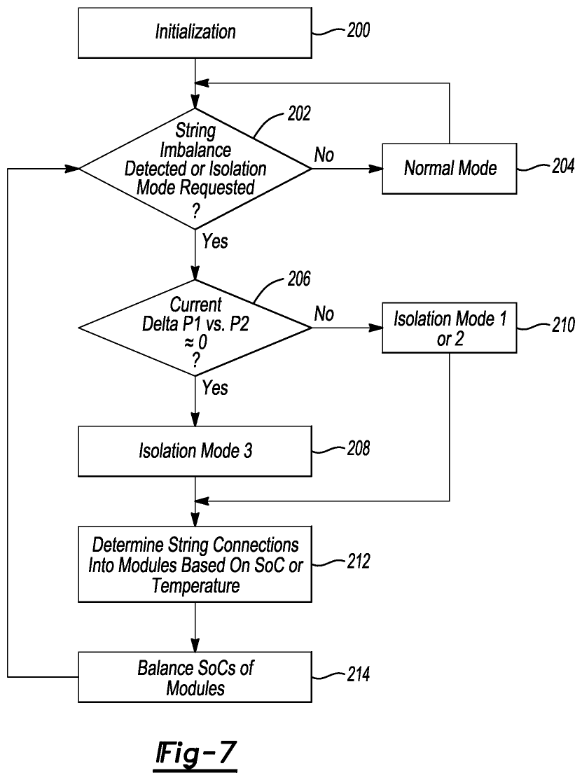

A routine for determining which isolation mode, if any, among Isolation Mode 1, Isolation Mode 2 and Isolation Mode 3 should be entered is illustrated in FIG. 7. There, after entering the routine at block 200, it is determined at block 202 whether an isolation mode is requested or whether an imbalance of states of charge among strings 20-30 is detected. An isolation mode may be requested by the vehicle electrical system if a fault is detected on bus P1 or bus P2. An isolation mode may also be requested by the battery pack if a state of charge or temperature imbalance is detected If the answer at block 202 is NO, then the routine may remain in normal mode (block 204), where all strings 20-30 are connected to both bus P1 and to bus P2. If YES, then it is determined whether there is a difference in current drawn from bus P1 and from bus P2 (block 206); the difference in the currents may be compared to a threshold to determine whether the difference is significant enough to assign a different number of strings to bus P1 and to bus P2. If YES, then Isolation Mode 3 may be entered at block 208. (Recall that in Isolation Mode 3 (see FIG. 6A and FIG. 6B), the number of strings connected to bus P1 and to bus P2 is equal.) If the answer at block 210 is NO, then Isolation Mode 1 or Isolation Mode 2 may be entered at block 210. By examination of FIG. 4A, FIG. 4B, FIG. 4C and FIG. 5A, FIG. 5B, and FIG. 5C, it is apparent that if more current is drawn from bus P1, then Isolation Mode 1 (FIG. 4A, FIG. 4B, and FIG. 4C) may be selected, as more strings are connected to bus P1 than to bus P2 in Isolation Mode 1. On the other hand, if more current is drawn from bus P2, then Isolation Mode 2 (FIG. 5A, FIG. 5B, and FIG. 5C) may be selected, as more strings are connected to bus P2 than to bus P1 in Isolation Mode 2.

Then, at block 212, the assignment of individual strings among strings 20-30 into module 90, module 92, and module 94 may be performed. As is apparent from the illustrative example of FIG. 3, there is a high degree of flexibility in switching of strings 20-30 to constitute module 90, module 92, and module 94. An individual string 20, string 22, string 24, string 26, string 28, or string 30 may be assigned to a module 90, module 92, or module 94 based on the state of charge of the individual string. Strings with relatively higher states of charge may be assigned to a module or modules coupled to a bus (bus P1 or bus P2) having a relatively higher current demand on it. Alternatively or additionally, strings with relatively lower internal temperatures may be assigned to a module or modules coupled to a bus (bus P1 or bus P2) with a relatively higher current-supply capacity as a means to begin raising the temperatures of the strings with lower temperatures. A “relatively higher state of charge” of a string may be a state of charge that is higher than an average state of charge of all of strings 20-30. A “relatively lower internal temperature” of a string may be an internal temperature that is lower than an average internal temperature of all of strings 20-30.

A model for the system described here is illustrated in the table shown in FIG. 10. There, row 300 of the table illustrates Isolation Mode 1, row 302 illustrated Isolation Mode 2, and row 304 illustrates Isolation Mode 3. Further, each isolation mode may have multiple phases, or ways, in which the modules are interconnected to realize that isolation mode. Column 310 illustrates a Phase 1, Column 312 illustrates a Phase 2, and Column 314 illustrates a Phase 3; in this illustrative disclosure, Phase 3 is relevant for Isolation Mode 1 and Isolation Mode 2, but not for Isolation Mode 3. The model illustrated in FIG. 10 is by way of example. In general, there may be more isolation modes and more phases than shown in FIG. 10.

Phase 1 of Isolation Mode 1 is designated in the table of FIG. 10 as “P₁P₁P₂”, designating that in that phase, module 90 and module 92 are connected to bus P1 and module 94 is connected to bus P2 (see FIG. 4A). Phase 2 of Isolation Mode 1 is designated in the table of FIG. 10 as “P₂P₁P₁”, designating that in that phase, module 90 is connected to bus P2 and module 92 and module 94 are connected to bus P1 (see FIG. 4B). Phase 3 of Isolation Mode 1 is designated in the table of FIG. 10 as “P₁P₂P₁”, designating that in that phase, module 90 and module 94 are connected to bus P1 and module 92 is connected to bus P2 (see FIG. 4C). The foregoing description in this paragraph is consistent with the indication earlier in this disclosure that in Isolation Mode 1, two of module 90, module 92 and module 94 are connected to bus P1 and the remaining module is connected to bus P2.

In Model Predictive Control, constraints are placed on elements of the control. Column 316, the “Constraint” column, illustrates such constraints here. The normalized amount of time spent in each phase while in the relevant isolation mode is represented by column 316, the “Constraint” column. There, d₁ is the normalized amount of time in Phase 1 while the system is in Isolation Mode 1, d₂ is the normalized amount of time the system is in Phase 2 while the system is in Isolation Mode 1, and d₃ is the normalized amount of time in Phase 3. The sum of the three normalized times is 1, as in Isolation Mode 1, the system is in either Phase 1, Phase 2, or Phase 3 for 100% of the time.

Further, then, column 318 of the table of FIG. 10 is an algebraic model for the isolation modes. For example, for Isolation Mode 1 (row 300), the relationships among normalized connection times to bus P1 (u₁ for module 90, u₂ for module 92, and u₃ for module 94) and normalized connection times to bus P2 (z₁ for module 90, z₂ for module 92 and z₃ for module 94) are shown. Additionally, then, the model includes in column 320 two matrices that indicate the states of connection of module 90, module 92, and module 94 to buses P1 and P2. Matrix Aₘ represents the connection states of module 90, module 92, and module 94 to bus P1; each row of matrix Aₘ represents one of the phases. Matrix Bₘ, then, represents the connection states of module 90, module 92, and module 94 to bus P2. In each matrix, a “1” represents a closed (or ON) state, and a “0” represents an open (or OFF) state.

An objective of the control while the system is in any of the isolation modes may be to employ switching among the phases (e.g., Phase 1, Phase 2, and Phase 3 of Isolation Mode 1 or Isolation Mode 2 or Phase 1 and Phase 2 of Isolation Mode 3) to effect a reduction in state of charge imbalance among the modules or in other words, to increase equalization of the states of charge among the modules.

Phase 1 of Isolation Mode 2 (row 302) is designated in the table of FIG. 10 as “P₁P₂P₂”, denoting that in that phase, module 90 is connected to bus P1 and module 92 and module 94 are connected to bus P2 (see FIG. 5A). Phase 2 of Isolation Mode 1 (row 302) is designated in the table of FIG. 10 as “P₂P₁P₂”, denoting that in that phase, module 92 is connected to bus P1 and module 90 and module 94 are connected to bus P2 (see FIG. 5B). Phase 3 of Isolation Mode 1 is designated in the table of FIG. 10 as “P₂P₂P₁”, denoting that in that phase, module 94 is connected to bus P1 and module 90 and module 92 are connected to bus P2 (see FIG. 5C). The foregoing description in this paragraph is consistent with the description earlier in this disclosure that in Isolation Mode 2, two of module 90, module 92 and module 94 are connected to bus P2 and the remaining module is connected to bus P1.

Phase 1 (column 310) of Isolation Mode 3 (row 304) is designated in the table of FIG. 10 as “P₁P₂”, denoting that in that phase, module 100 is connected to bus P1 and module 102 is connected to bus P2 (see FIG. 6A). Phase 2 of Isolation Mode 3 is designated in the table of FIG. 10 as “P₂P₁”, denoting that in that phase, module 102 is connected to bus P1 and module 100 is connected to bus P2 (see FIG. 6B).

Model predictive control (MPC) is then applied at block 214 by BCU 80 and/or other controllers in vehicle 10. The objective of the model predictive control is to bring the states of charge of module 90, module 92 and module 94 or module 100 and module 102 into improved balance. (The “state of charge” of a module as referred to herein may be considered the average states of charge of the module's constituent strings.)

At block 214:

$${q}_{m} ( k + 1 ) = {q}_{m} ( k ) + \frac{Δ t}{{Q}_{m}} ( {i}_{p 1} ( k ) {u}_{m} ( k ) + {i}_{p 2} ( k ) {z}_{m} ( k ) ) = {q}_{m} ( k ) + \frac{Δ t}{{Q}_{m}} ( {i}_{p 1} ( k ) {A}_{m} ( mode ) + {i}_{p 2} ( k ) {B}_{m} ( mode ) ) [ \begin{matrix}{d}_{1} \\ {d}_{2} \\ {d}_{3}\end{matrix} ] , \qquad ( Equation 1 )$$

where
m=1, 2, . . . , nₘ;
nₘ is the number of modules (3 for this example);
   Δt is the time elapsed between intervals of “k”;
qₘ is the averaged state of charge between the strings comprising module m;
   Qₘ is the capacity of module m (i.e., collective capacity of the strings comprising module m;
uₘ represents module m being connected to bus P1;
zₘ represents module m being connected to bus P2;
   iₚ₁ is current flow to/from bus P1;
iₚ₂ is current flow to/from bus P2; and

$$[ \begin{matrix}{d}_{1} \\ {d}_{2} \\ {d}_{3}\end{matrix} ]$$

is a matrix representing the normalized phase duration of Phase 1, Phase 2, and Phase 3.

Then, quadratic programming works to minimize the quadratic cost J over a finite horizon N:

$$J = {\sum }_{k = 1}^{N} ( y ( k ) + {R}_{u} ( k ) ) , \qquad ( Equation 2 )$$

$$where$$

$$y ( k ) = {\sum }_{m = 1}^{{n}_{m} - 1} {( {q}_{m + 1} ( k ) - {q}_{m} ( k ) )}^{2} + {( {q}_{{n}_{m}} ( k ) - {q}_{1} ( k ) )}^{2} \qquad ( Equation 3 )$$

$$and$$

$${R}_{u} ( k ) = R \times {\sum }_{m = 1}^{{n}_{m}} {d}_{m}^{2} ( k ) , \qquad ( Equation 4 )$$

with the aforementioned constraint that

$${\sum }_{m = 1}^{{n}_{m}} {d}_{m} = 1 , where {d}_{m} \geq 0.$$

Finally, then, once the minimized cost J is calculated over the respective finite time horizon, modules 90, 92, and 94 are switched into the states (u, connected to bus P1 or z, connected to bus P2) for the durations, time periods, or time intervals d₁ for module 90, d₂ for module 92, and d₃ for module 94 for the next step. The calculation of J then iterates again while the system is in Isolation Mode 1.

Equation 3 above works to calculate the difference of squares of the state of charge among module 90, module 92, and module 94; difference of squares is used so that each way that there may be an imbalance between modules (e.g., whether module 90 has greater or lesser state of charge compared to module 92) will be treated in the same way. Equation 4 is a model predictive control (MPC) “penalty” factor that “penalizes” overswitching among module 90, module 92, and module 94.

When the system is in Isolation Mode 2 (row 302), a similar charge balancing may be performed. Similar charge balancing may also be performed in Isolation Mode 3 (row 304), realizing that in Isolation Mode 3, there are only two modules, module 100 and module 102, and therefore only two phases.

It has been demonstrated that the charge balancing method illustrated herein will cause the states of charge of the modules, which may have drifted in the operation of vehicle 10, to move toward convergence. That is, the equalization of the states of charge of the modules may be increased.

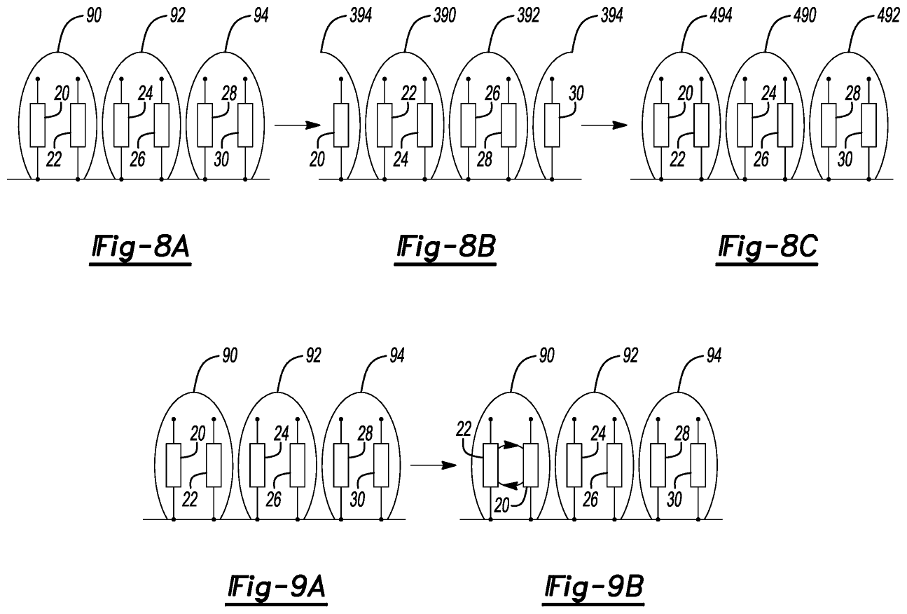

A variation on the charge balance system and method described herein is illustrated with reference to FIG. 8A, FIG. 8B, and FIG. 8C. There, the grouping of strings 20-30 into modules may be variable. That is, in FIG. 8A, string 20 and string 22 may be in module 90, string 24 and string 26 may be in module 92, and string 28 and string 30 may be in module 94. This is, in fact, the configuration shown in FIG. 4A, FIG. 4B, and FIG. 4C, and FIG. 5A, FIG. 5B, and FIG. 5C. However, after a period of charge balancing in Isolation Mode 1 or Isolation Mode 2, the mapping of strings into modules may be modified. As shown in FIG. 8B, string 22 and string 24 may now be considered constituents of a first module 390, string 26 and string 28 may be considered constituents of a second module 392, and string 30 and string 20 may be considered constituents of a third module 394. That is, the strings 20-30 may be “shifted” into alternate module configurations. The charge balancing among the modules may then be performed again. FIG. 8C shows a third module configuration into which strings 20-30 may be shifted, (string 24 and string 26 in a module 490, string 28 and string 30 in a module 492, and string 20 and string 22 in a module 494) after which charge balancing among the modules may then be performed again. A result of the balancing and shifting sequence is that the states of charge of odd strings (say, the first strings) in the modules and even strings (say, the second strings) in the modules converge with one another, along with convergence of the averaged state of charges among the modules.

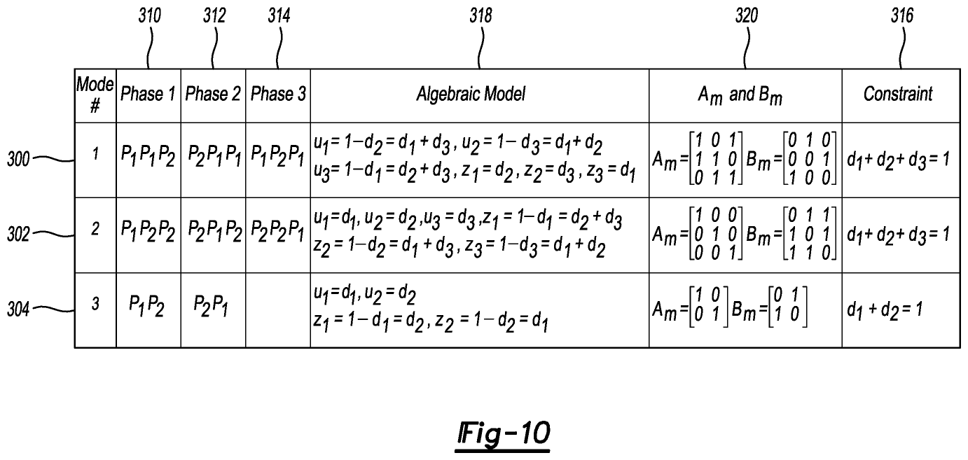

A further variation on the charge balancing system and method as described herein is illustrated with reference to FIG. 9A and FIG. 9B. There, again the grouping of strings 20-30 within modules may be variable. That is, in FIG. 9A, string 20 and string 22 may be in module 90, string 24 and string 26 may be in module 92, and string 28 and string 30 may be in module 94, in the orders shown in FIG. 9A. This is, in fact, the configuration shown in FIG. 4A, FIG. 4B, and FIG. 4C, and FIG. 5A, FIG. 5B, and FIG. 5C. However, between events of string “shifting”, after a period of charge balancing in Isolation Mode 1 or Isolation Mode 2, the positions of the strings within the modules may be “swapped”. As shown in FIG. 9B, string 20 and string 22 may be swapped within module 90. Here, it is apparent that “swapping” is used to refer to switching or reconfiguring strings within a module.

String shifting and string swapping may be employed in conjunction with the charge balancing described herein. When in a particular isolation mode, string shifting may alternate with string swapping; charge balancing may occur between string shifting events and string swapping events. It has been demonstrated that incorporating string shifting and string swapping along with charge balancing provides particularly effective balancing of state of charge not only among the modules but also among strings 20-30.

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure.

Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims. Moreover, this disclosure expressly includes combinations and sub-combinations of the elements and features presented above and below.

What is claimed is:

1. A method for controlling a plurality of energy storage elements in a vehicle having a first power bus and a second power bus, the method comprising:
for a first time interval, connecting a first subset of the plurality of energy storage elements to the first power bus and a second subset of the plurality of energy storage elements to the second power bus; and
for a second time interval, connecting the first subset of energy storage elements to the second power bus and the second subset of energy storage elements to the first power bus to increase equalization of states of charge between the first subset of energy storage elements and the second subset of energy storage elements.

2. The method of claim 1, further comprising:
selecting at least two of the energy storage elements based at least in part on their states of charge; and
including the at least two energy storage elements in the first subset of the plurality of energy storage elements.

3. The method of claim 1, further comprising:
selecting at least two of the energy storage elements based at least in part on their temperatures; and
including the at least two energy storage elements in the first subset of the plurality of energy storage elements.

4. The method of claim 1, wherein the first time interval and the second time interval are determined by one or more controllers using model predictive control.

5. The method of claim 1, wherein the first time interval and the second time interval are each greater than or equal to zero seconds.

6. The method of claim 1, further comprising:
changing connections among the plurality of energy storage elements so that one of the energy storage elements of the first subset of the plurality of energy storage elements is contained in the second subset of energy storage elements and one of the energy storage elements of the second subset of energy storage elements is contained in the first subset of energy storage elements;
for a third time interval, connecting the first subset of the plurality of energy storage elements to the first power bus and the second subset of the plurality of energy storage elements to the second power bus; and
for a fourth time interval, connecting the first subset of energy storage elements to the second power bus and the second subset of energy storage elements to the first power bus to increase equalization of states of charge between the first subset of energy storage elements and the second subset of energy storage elements.

7. The method of claim 6, wherein the third time interval and the fourth time interval are determined by one or more controllers using model predictive control.

8. The method of claim 1, further comprising:
changing connections among the plurality of energy storage elements so that one of the energy storage elements of the first subset of the plurality of energy storage elements is swapped in the first subset of energy storage elements with one other of the energy storage elements in the first subset of energy storage elements;
for a third time interval, connecting the first subset of the plurality of energy storage elements to the first power bus and the second subset of the plurality of energy storage elements to the second power bus; and
for a fourth time interval, connecting the first subset of energy storage elements to the second power bus and the second subset of energy storage elements to the first power bus to increase equalization of states of charge between the first subset of energy storage elements and the second subset of energy storage elements.

9. The method of claim 8, wherein the third time interval and the fourth time interval are determined by one or more controllers using model predictive control.

10. The method of claim 6, further comprising:
changing connections among the plurality of energy storage elements so that one of the energy storage elements of the first subset of the plurality of energy storage elements is swapped in the first subset of energy storage elements with one other of the energy storage elements in the first subset of energy storage elements;
for a fifth time interval, connecting the first subset of the plurality of energy storage elements to the first power bus and the second subset of the plurality of energy storage elements to the second power bus; and
for a sixth time interval, connecting the first subset of energy storage elements to the second power bus and the second subset of energy storage elements to the first power bus to increase equalization of states of charge between the first subset of energy storage elements and the second subset of energy storage elements.

11. A method for controlling a plurality of energy storage elements in a vehicle, the method comprising:
identifying a plurality of subsets of the energy storage elements;
for a first time interval:
connecting a first group of subsets, comprising one or more of the plurality of subsets, to a first power bus in the vehicle; and
connecting a second group of subsets, representing a remainder of the plurality of subsets not in the first group, to a second power bus in the vehicle;
selecting a first number of the subsets in the first group;
selecting a second number of the subsets in the second group, the first number being equal to the second number; and
for a second time interval:
connecting the selected subsets in the first group to the second power bus; and
connecting the selected subsets in the second group to the first power bus.

12. The method of claim 11, further comprising selecting the first time interval and the second time interval using model predictive control.

13. The method of claim 11, wherein the method increases a state of charge balance among the subsets of energy storage elements.

14. The method of claim 13, further comprising selecting the first time interval and the second time interval using model predictive control.

15. A vehicle comprising:
a first power bus;
a second power bus;
a plurality of energy storage elements; and
one or more controllers collectively executing the following instructions:
for a first time interval, connect a first subset of the plurality of energy storage elements to the first power bus and a second subset of the plurality of energy storage elements to the second power bus; and
for a second time interval, connect the first subset of energy storage elements to the second power bus and the second subset of energy storage elements to the first power bus.

16. The vehicle of claim 15, further comprising one or more controllers that execute an instruction to select at least two energy storage elements based at least in part on their states of charge to include in the first subset of the plurality of energy storage elements.

17. The vehicle of claim 15, further comprising one or more controllers that execute an instruction to select at least two energy storage elements based at least in part on their temperatures to include in the first subset of energy storage elements.

18. The vehicle of claim 15, wherein the first time interval and the second time interval are determined by one or more controllers using model predictive control to increase equalization of states of charge between the first subset of energy storage elements and the second subset of energy storage elements.

19. The vehicle of claim 15, further comprising one or more controllers that collectively execute the following instructions:
change connections among the plurality of energy storage elements so that at least one of the energy storage elements of the first subset of the plurality of energy storage elements is contained in the second subset of energy storage elements and at least one of the energy storage elements of the second subset of energy storage elements is contained in the first subset of energy storage elements;
for a third time interval, connect the first subset of the plurality of energy storage elements to the first power bus and the second subset of the plurality of energy storage elements to the second power bus; and
for a fourth time interval, connect the first subset of energy storage elements to the second power bus and the second subset of energy storage elements to the first power bus to increase equalization of states of charge between the first subset of energy storage elements and the second subset of energy storage elements.

20. The vehicle of claim 19, wherein the third time interval and the fourth time interval are calculated by one or more controllers using model predictive control.
